(19) United States
(12) Patent Application Publication
(10) Pub. No.: US 2010/0127588 A1
(43) Pub. Date: May 27, 2010

(54) Motor

(76) Inventor: Alex Horng, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/344,466

(22) Filed: Dec. 27, 2008

(30) Foreign Application Priority Data
Nov. 25, 2008 (TW) 97145435

(51) Int. Cl. H02K 5/16

(52) U.S. Cl. 310/90

(57) ABSTRACT

A motor includes a base, a stator, a bearing, a positioning member and a rotor. The base includes a shaft tube. The stator is mounted around the shaft tube. The bearing is received in the shaft tube. The positioning member is fixed to an end of the shaft tube and has a pressing portion to prevent movement of the bearing in the shaft tube. A plurality of retaining plates is formed on the positioning member. Each retaining plate has a retaining end. The rotor includes a shaft having an annular groove formed in an outer periphery thereof. The retaining ends of the retaining plates are in the annular groove to avoid departure of the rotor from the base. Consequently, by a single-component design of the positioning member, departures of the rotor and the bearing are both avoided.

### BACKGROUND OF THE INVENTION

1. Field of the Invention

The present invention relates to a motor and, more particularly, to a motor that can prevent a bearing and a rotor from disengaging.

2. Description of the Related Art

Referring to FIG. 1, a conventional motor 8 includes a base 81 having a shaft tube 811, a stator 82 mounted around the shaft tube 811, a retaining ring 83 disposed in the shaft tube 811, a bearing 84 received in the shaft tube 811, an abutting ring 85 coupling inside the shaft tube 811 by close-fit, and a rotor 86 having a shaft 861. The abutting ring 85 abuts against a top of the bearing 84 to avoid the bearing 84 and the retaining ring 83 disengaging from the shaft tube 811. The shaft 861 of the rotor 86 passes through the abutting ring 85 to couple to the bearing 84 and the shaft 861 is retained by the retaining ring 83, such that disengagement of the rotor 86 from the base 81 is avoided during rotation of the rotor 86.

However, after a long-term operation of the conventional motor 8, deformation of the shaft tube 811 is easily caused due to heat expansion and cold shrinkage as well as stress generated during operation of the motor 8. Thus, the abutting ring 85 can not be securely fitted in the shaft tube 811 to press and restrict the bearing 84 and that results in movement of the bearing 84 inside the shaft tube 811. Therefore, life of the conventional motor 8 is reduced.

For overcoming the problems of the conventional motor 8, there are other kinds of conventional motor on the market, which can avoid movement of a bearing effectively, such as Taiwan Patent Publication No. 200814494 entitled “BEARING POSITIONING STRUCTURE FOR A MOTOR” and Taiwan Patent Publication No. 200814495 entitled “RETAINING STRUCTURE FOR MOTOR COMPONENTS”. For example, as illustrated in FIG. 2, a conventional motor 9 includes a base 91 having a shaft tube 911, a stator 92 mounted around the shaft tube 911, a retaining seat 93, a bearing 94, a positioning member 95 and a rotor 96. The retaining seat 93 and the bearing 94 are received in the shaft tube 911. The rotor 96 has a shaft 961 rotatably coupling to the bearing 94. The shaft tube 911 of the base 91 includes a coupling section 912 that extends radially and annularly on an end edge of the shaft tube 911. A pressing portion 951 and a hook-shaped coupling portion 952 are formed on a bottom of the positioning member 95, with the pressing portion 951 extending axially from the bottom of the positioning member 95 and being surrounded by the coupling portion 952. Hence, the coupling portion 952 can engage with the coupling section 912 of the shaft tube 911 for the positioning member 95 to avoid disengaging from the shaft tube 911, and the pressing portion 951 can press against the bearing 94 to secure the bearing 94 inside the shaft tube 911. Therefore, the positioning member 95 effectively prevent the bearing 94 from moving inside the shaft tube 911 to enhance life of the motor 9. Nevertheless, said conventional motor 9 has several drawbacks in use as the following.

First, the motor 9 has a complex structure. The retaining seat 93 and the positioning member 95 are indispensable to the motor 9 in avoiding disengagement of the rotor 96 from the base 91 and pressing the bearing 94 for positioning the bearing 94 in the shaft tube 911 respectively. Plus the formation of the coupling section 912 is necessary for coupling portion 952 of the positioning member 95 to engage. Thus, the motor 9 is designed to have a plural-component structure with the retaining seat 93 and the positioning member 95 to achieve prevention of disengagement of the rotor 96 and the bearing 94, and it resulted in the complex structure.

Second, inconvenience of assembling is caused. There are too many components, such as the base 91, the stator 92, the retaining seat 93, the bearing 94, the positioning member 95 and the rotor 96, to be assembled, and that results in a complex structure for assembly. Furthermore after settling down the retaining seat 93, the bearing 94 and the positioning member 95, the shaft 961 should be passed through said three components, and it's difficult to make sure whether the retaining seat 93 and the shaft 961 is mounted to each other or not because the retaining seat 93 is inside the shaft tube 911 and at the bottom thereof. Thus, difficulty in assembling the motor 9 is caused.

Third, revolving instability is caused. A distal part of the shaft 961, which has a predetermined length in a longitudinal direction of the shaft 961, is below the bearing 94 and received in the retaining seat 93 for the retaining seat 93 to mount around. However, obviously, the distal part of the shaft 961 can not revolvably couple with the bearing 94, and thus low revolving stability of the rotor 96 is caused, for a support area between the shaft 961 and the bearing 94 is reduced.

Hence, there is a need for an improvement over the conventional motor.

### SUMMARY OF THE INVENTION

The primary objective of the present invention is to provide a motor that solves the problems of the conventional motor and avoids disengagement of the rotor and the bearing by a single-component design.

A motor according to the preferred teachings of the present invention includes a base, a stator, a bearing, a positioning member and a rotor. The base includes a shaft tube with a closed end and an open end. The stator is mounted around the shaft tube. The bearing includes a first end face, a second end face and an axial hole connecting with the first and second end faces, with the bearing being received in the shaft tube. The positioning member includes a body fixed to the open end of the shaft tube, with a bottom face of the body that faces the shaft tube forms a pressing portion. A plurality of retaining plates is formed on an inner radial periphery of the body and extends inwards radially, with a slit being formed between a pair of retaining plates adjacent to each other. Each retaining plate has a retaining end that is a free end of each retaining plate without contacting with the body. The retaining ends jointly define a through hole aligned with the axial hole of the bearing. The rotor includes a shaft passing through the through hole of the positioning member and the axial hole of the bearings. The shaft has an annular groove formed in an outer periphery thereof to form a neck of the shaft. The neck is in the through hole of the positioning member while a periphery of the through hole of the positioning member surrounds the annular groove. The retaining ends of the retaining plates are in the annular groove. Accordingly, by a single-component design of the positioning member, departures of the rotor and the bearing are both avoided, so that a simplified structure, convenience of assembling and enhanced revolving stability are provided.

In a most preferred form, a coupling section is formed on an end edge of the shaft tube and adjacent to the open end of the shaft tube, and a coupling portion is formed on an outer bottom edge of the body and surrounding the pressing portion, with the coupling portion engaging with the coupling section. Accordingly, the positioning member is assuredly fixed to the open end of the shaft tube securely to press the bearing effectively.

In a most preferred form, an outer circumference of the shaft tube forms an auxiliary engaging portion between the closed end and the open end of the shaft tube, and a bottom of the stator forms a first connecting portion engaging with the auxiliary engaging portion. Accordingly, coupling stability between the positioning member and the shaft tube is enhanced.

In a most preferred form, a top of the stator forms a second connecting portion engaging with an outer radial periphery of the body of the positioning member. Accordingly, the positioning member is assuredly fixed to the open end of the shaft tube securely to press the bearing effectively.

In a most preferred form, an annular protrusion is formed on the inner periphery of the body and above the retaining plates to define a hole for the shaft to pass through; or alternatively, an annular wall is formed on a top of the body of the positioning member and extends axially, with the annular wall being outside the shaft tube and surrounding the shaft. Accordingly, dust-proof effect is provided to prevent dust or impurities from entering the shaft tube.

In a most preferred form, the pressing portion abuts against the second end face of the bearing; or alternatively, a washer is disposed inside the shaft tube and on the second end face of the bearing, with the pressing portion abutting against the washer. Accordingly, the bearing is retained in the shaft tube without any movement by the direct or indirect abutting of the pressing portion.

Further scope of the applicability of the present invention will become apparent from the detailed description given hereinafter. However, it should be understood that the detailed description and specific examples, while indicating preferable embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a cross sectional view illustrating a conventional motor;

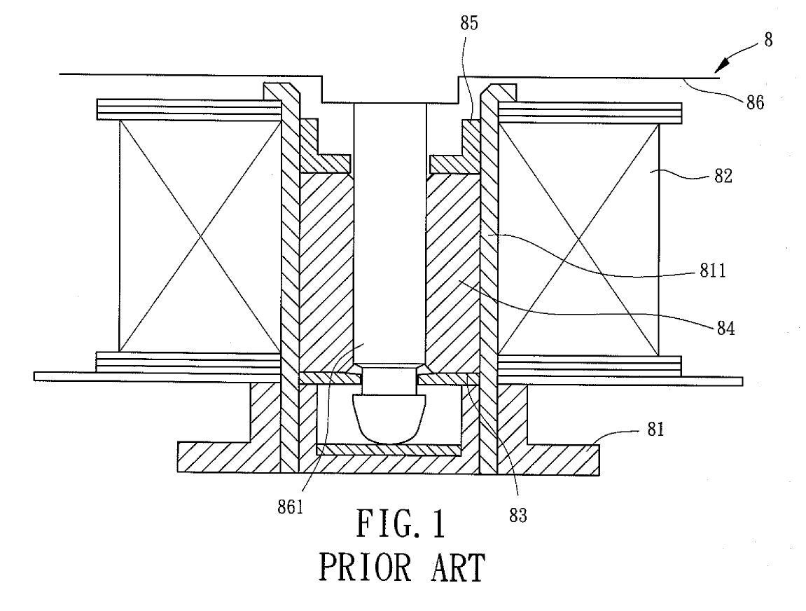

FIG. 2 is a cross sectional view illustrating another conventional motor;

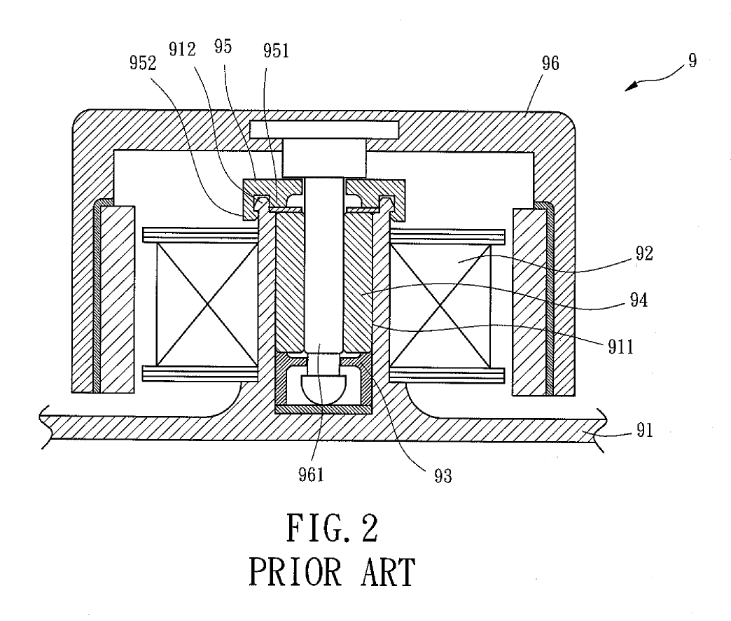

FIG. 3 is an exploded perspective view illustrating a motor in accordance with a first embodiment of the present invention;

FIG. 4 is a cross sectional view illustrating the motor in accordance with the first embodiment of the present invention;

FIG. 5 is an exploded perspective view illustrating a motor in accordance with a second embodiment of the present invention;

FIG. 6 is a cross sectional view illustrating the motor in accordance with the second embodiment of the present invention;

FIG. 7 is an exploded perspective view illustrating a motor in accordance with a third embodiment of the present invention; and

FIG. 8 is a cross sectional view illustrating the motor in accordance with the third embodiment of the present invention.

In the various figures of the drawings, the same numerals designate the same or similar parts. Furthermore, when the terms “first”, “second”, “annular”, “axial”, “radial”, “outer”, “inner”, “section”, “portion”, “end”, and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

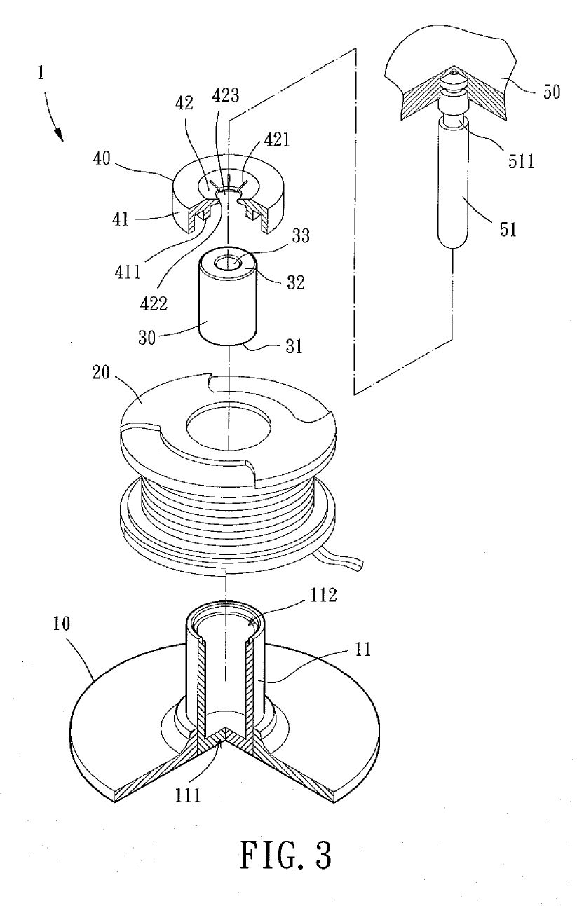

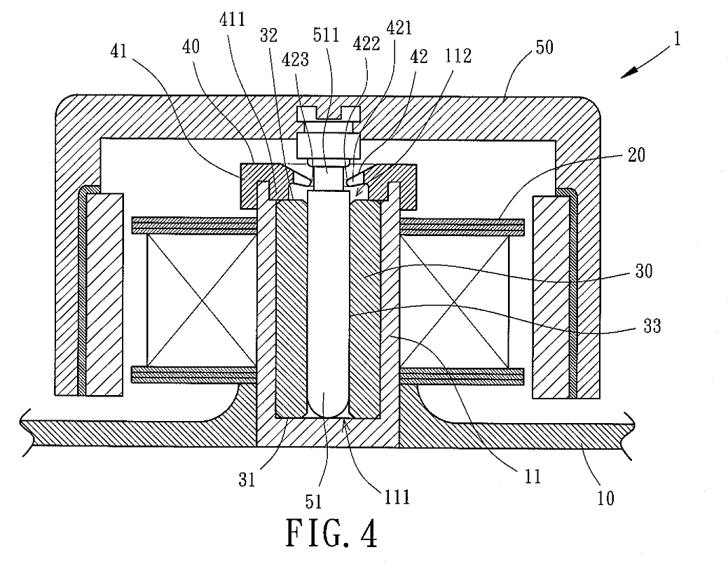

A motor designated 1 of a first embodiment according to the preferred teachings of the present invention is shown in FIGS. 3 and 4 of the drawings. According to the first embodiment form shown, the motor includes a base 10, a stator 20, a bearing 30, a positioning member 40, and a rotor 50.

The base 10 can be designed as a frame of a fan, such that the motor of the present invention can be utilized for a heat-dissipating fan. In the first embodiment, the base 10 has a shaft tube 11 and two ends of the shaft tube 11 are a closed end 111 and an open end 112.

The stator 20 is mounted around the shaft tube 11 of the base 10 to drive the rotor 50 to revolve.

The bearing 30 has a first end face 31, a second end face 32 and an axial hole 33 connecting with the first end face 31 and the second end face 32. And the bearing 30 is received in the shaft tube 11 of the base 10, with the first end face 31 and the second end face 32 being adjacent to the closed end 111 and the open end 112 respectively.

The positioning member 40 has a body 41 that is preferably in the shape of a ring. The body 41 is fixed to the open end 112 of the shaft tube 11 of the base 10 by engagement, adhesive, welding or other methods. A bottom face of the body 41 forms a pressing portion 411 that extends axially into the shaft tube 11 to press against the bearing 30, so that axial movement of the bearing 30 inside the shaft tube 11 is avoided. Optionally, the pressing portion 411 presses against the bearing 30 directly or indirectly. Specifically, as shown in FIG. 4, the pressing portion 411 directly presses against the second end face 32 of the bearing 30, such that the bearing 30 is securely sandwiched and positioned between the positioning member 40 and the closed end 111 of the shaft tube 11. Otherwise, the pressing portion 411 presses against a washer (not illustrated) mounted on the second end face 32 of the bearing 30. Besides, the positioning member 40 further includes a plurality of retaining plates 42 formed on an inner radial periphery of the body 41 and extending inwards radially, with a slit 421 being formed between a pair of retaining plates 42 adjacent to each other to provide the retaining plates 42 with improved deforming ability. Each retaining plate 42 has a retaining end 422 that is a free end of the retaining plate 42 without contacting with the body 41, with the retaining ends 422 of the retaining plates 42 jointly defining a through hole 423 aligned with the axial hole 33 of the bearing 30.

The rotor 50 has a shaft 51 with one end thereof rotatably extending into the bearing 30. An annular groove 511 is formed in an outer periphery of the shaft 51 to form a neck of the shaft 51, with the annular groove 511 being close to the other end of the shaft 51. In addition, the neck of the shaft 51 has an outer diameter smaller than that of two sections of the shaft 51, with said two sections being adjacent to two end edges of the annular groove 511. The outer diameter of the neck of the shaft 51 is smaller than a diameter of the through hole 423 of the positioning member 40 and the outer diameters of the two sections adjacent to the neck of the shaft 51 are slightly larger than the diameter of the through hole 423 of the positioning member 40. Hence, the positioning member 40 is mounted around the shaft 51, after the shaft 51 is forcibly inserted through the through hole 423 of the retaining member 40 to be rotatably received in the axial hole 33 of the bearing 30. With the above-mentioned structure, the neck of the shaft 51 is in the through hole 423 of the positioning member 40 while a periphery of the through hole 423 of the positioning member 40 surrounds the annular groove 511 of the shaft 51. Besides, the retaining plates 42 of the retaining member 40 extends into the annular groove 511 of the shaft 51, with the retaining ends 422 of the retaining plates 42 being in the annular groove 511 to retain the shaft 51. Therefore, by the retaining plates 42 of the retaining member 40, departure of the rotor 50 from the base 10 is avoided during packing, loading and unloading, conveyance or operation of the motor 1.

In use of the motor 1 of the first embodiment according to the preferred teachings of the present invention, the stator 20 is provided with an electric current to generate alternative magnetic fields, and thus the rotor 50 with a permanent magnet (not illustrated) is driven by the alternative magnetic fields to revolve. The rotor 50 may couple to a plurality of blades (not illustrated) on an outer periphery thereof to be jointly regarded as an impeller when the motor of the present invention is used as a heat-dissipating fan.

The motor 1 of the present invention is characterized in that the positioning member 40 is fixedly attached to the open end 112 of the shaft tube 11 while the pressing portion 411 of the positioning member 40 abuts against the bearing 30 to retain the bearing 30 inside the shaft tube 11. Additionally, the retaining ends 422 of the retaining plates 42 of the positioning member 40 are in the annular groove 511 of the rotor 50 to provide a retaining effect to avoid the rotor 50 disengaging from the base 10. Therefore, departures of the rotor 50 and the bearing 30 are both avoided by a single-component design of the positioning member 40.

The followings are other embodiments according to the preferred teachings of the present invention. It is noted that the major difference between the first embodiment and said other embodiments are configuration of the positioning member and the ways to couple the positioning member to the shaft tube of the base.

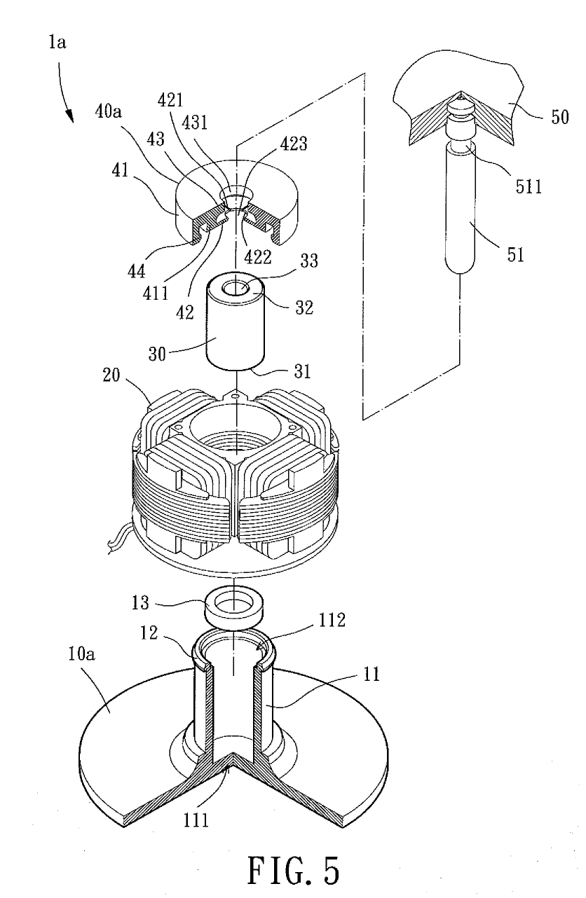

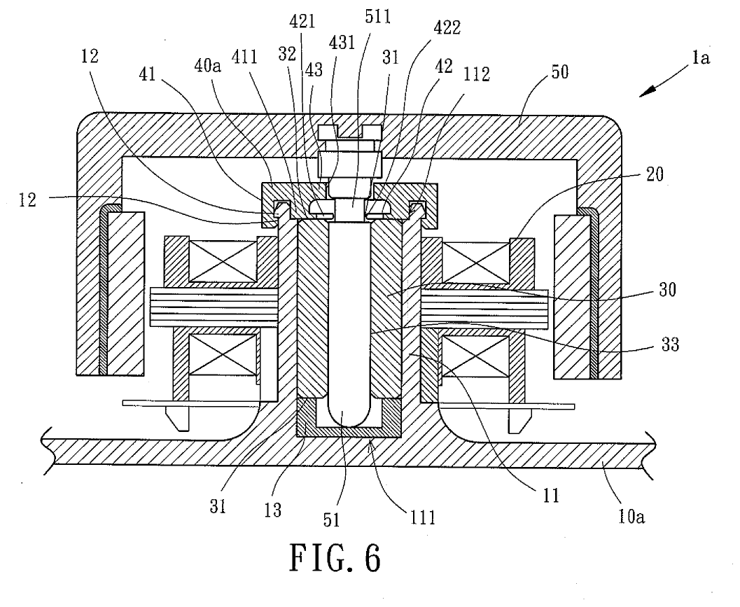

FIGS. 5 and 6 show a motor 1a of a second embodiment according to the preferred teachings of the present invention. The motor 1a includes a base 10a, a stator 20, a bearing 30, a positioning member 40a and a rotor 50 wherein the stator 20, the bearing 30 and rotor 50 are similar to those of the motor 1 of the first embodiment and descriptions thereof are therefore omitted.

The base 10a of the second embodiment according to the preferred teachings of the present invention has a shaft tube 11 with a closed end 111 and an open end 112. The shaft tube 11 includes a coupling section 12 selected from annular flange, a plurality of blocks, a plurality of holes or others which can allow the positioning member 40a to engage with the coupling section 12. Preferably, the coupling section 12 is an annular flange that extends radially on an end edge of the shaft tube 11 as shown in FIG. 5, with the coupling section 12 being adjacent to the open end 112 of the shaft tube 11. Furthermore, a wear-resisting plate 13 is received in the shaft tube 11 and at the closed end 111, so as to abut upon the shaft 51 to prevent the abrasions of the shaft 51 and the base 10a during rotation of the rotor 50.

The positioning member 40a of the second embodiment according to the preferred teachings of the present invention has a body 41 with a bottom face forming a pressing portion 411 that extends axially into the shaft tube 11. A plurality of retaining plates 42 is annularly formed on an inner radial periphery of the body 41. In the second embodiment, the retaining plates 42 extend radially from an inner periphery of the pressing portion 411, with the retaining plates 42 also having slits 421, retaining ends 422 and through hole 423 similar to those in the first embodiment and descriptions of them being thus omitted. An annular protrusion 43 is formed on the inner periphery of the body 41 and above the retaining plates 42 to define a hole 431, with a diameter of the hole 431 being slightly larger than the two sections of the shaft 51 adjacent to end edges of the annular groove 511 to minimized space between the shaft 51 and the annular protrusion 43. Hence, the annular protrusion 43 is able to provide dust-proof effect to prevent dust or impurities from entering the shaft tube 11 due to air currents resulting from rotation of the rotor 50, so that the rotor 50 is assured to rotate smoothly through the bearing 30 to prolong life of the motor 1a.

Moreover, the positioning member 40a of the second embodiment according to the preferred teachings of the present invention has a coupling portion 44 formed on an outer bottom edge of the body 41 and surrounding the pressing portion 411, with the coupling portion 44 engaging with the coupling section 12 of the base 10a to fix the positioning member 40a to the open end 112 of the shaft tube 11. The coupling portion 44 is selected from an annular flange with a hook-shaped cross-section, a plurality of blocks or other designs, which can achieve the function of engagement between positioning member 40a and the coupling section 12. As FIGS. 5 and 6 shown, the coupling portion 44 is an annular flange with a hook-shaped cross-section and spaced from the pressing portion 411 with a gap, with the open end 112 of the shaft tube 11 being wedged into the gap. Thus, the pressing portion 411 can unhinderedly abut against the second end face 32 of the bearing 30.

Therefore, the motor 1a of the second embodiment according to the preferred teachings of the present invention also can use the single-component design, namely the positioning member 40a, to achieve prevention of disengagement of the rotor 50 and the bearing 30. Besides, the positioning member 40a is assuredly firmly mounted on the open end 112 of the shaft tube 11 and provides dust-proof effect as well.

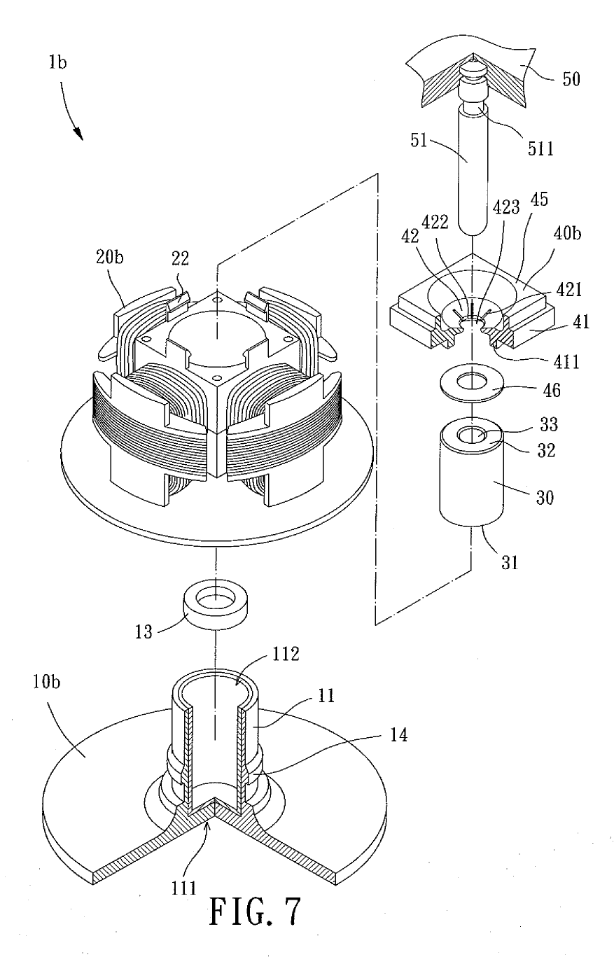

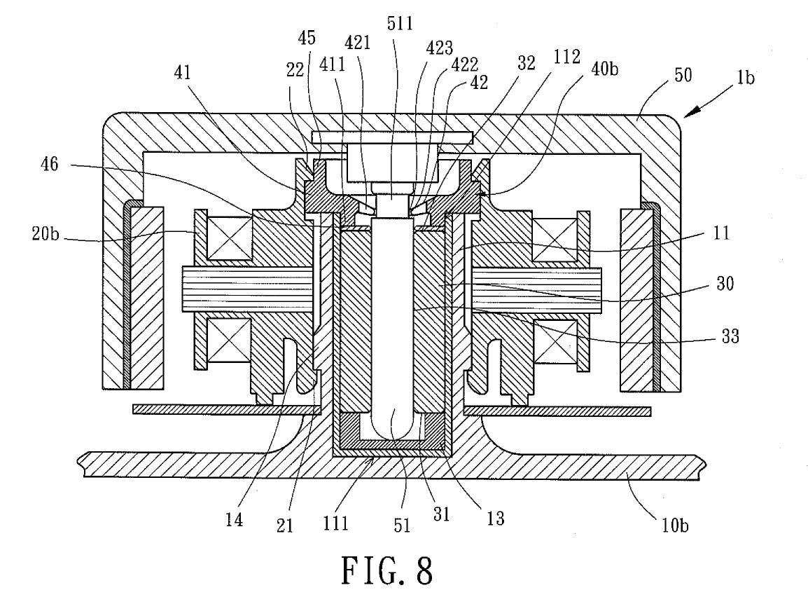

FIGS. 7 and 8, show a motor 1b of a third embodiment according to the preferred teachings of the present invention. The motor 1b includes a base 10b, a stator 20b, a bearing 30, a positioning member 40b and a rotor 50 wherein the bearing 30 and rotor 50 are similar to those of the motor 1 of the first embodiment and descriptions thereof are therefore omitted.

The base 10b of the third embodiment according to the preferred teachings of the present invention has a shaft tube 11 with a closed end 111 and an open end 112. Preferably, an outer circumference of the shaft tube 11 forms an auxiliary engaging portion 14, with the auxiliary engaging portion 14 being selected from an annular flange, a plurality of blocks, a plurality of holes or others which can allow the stator 20b to engages with the shaft tube 11. The auxiliary engaging portion 14 is an annular flange and between the closed end 111 and the open end 112 of the shaft tube 11. In addition, a wear-resisting plate 13 is received in the shaft tube 11.

A bottom and a top of the stator 20b of the third embodiment according to the preferred teachings of the present invention form a first connecting portion 21 and a second connecting portion 22 respectively. The first connecting portion 21 engages with the auxiliary engaging portion 14 of the base 10b, such that the stator 20b is securely mounted around the shaft tube 11. Each of the first connecting portion 21 and the second connecting portion 22 is selected from an annular flange, a plurality of blocks or others, which can be engaged with. Both of the first connecting portion 21 and the second connecting portion 22 in the third embodiment are plural blocks.

The positioning member 40b has a body 41 with a bottom face forming a pressing portion 411 that extends axially into the shaft tube 11. A plurality of retaining plates 42 is annularly formed on an inner periphery of the body 41, with the retaining plates 42 also having slits 421, retaining ends 422 and through hole 423 similar to those in the first embodiment and descriptions of them being thus omitted. In the third embodiment, the second connecting portion 22 of the stator 20b engages with an outer radial periphery of the body 41, while the positioning member 40b is disposed on the open end 112 of the shaft tube of the base 10b, such that the positioning member 40b can be fixed on the open end 112 of the shaft tube 11. An annular wall 45 is formed on a top of the body 41 of the positioning member 40b and extends axially, with the pressing portion 411 and the annular wall 45 being at two opposite axial end faces of the body 41. And a washer 46 is disposed inside the shaft tube 11 and on the second end face 32 of the bearing 30. While the positioning member 40 is fixed on the open end 112 of the shaft tube 11, the annular wall 45 is outside the shaft tube 11 and surrounds the shaft 51, with an end edge of the annular wall 45 is close to an inner top face of the rotor 50 to provide dust-proof effect. This avoids dusts or impurities from entering the shaft tube 11 due to air currents resulting from rotation of the rotor 50. Hence, life of the motor 1b is prolonged. Besides, the pressing portion 411 indirectly abuts against the bearing 30 through the washer 46 to prevent movement of the bearing 30 inside the shaft tube 11.

Therefore, the motor 1b of the third embodiment according to the preferred teachings of the present invention also can use the single-component design, namely the positioning member 40b, to prevent the rotor 50 and the bearing 30 from disengaging at the same time. And the dust-proof effect is also provided by the positioning member 40b that is firmly mounted on the open end 112 of the shaft tube 11. Besides, reliability of combination of the stator 20b and the base 10b is enhanced.

As has been discussed above, the motor 1, 1a, 1b is indeed able to overcome problems of the conventional motors and has many advantages as the following.

First, a simplified structure is provided. In contrast to the conventional motor 9 whose rotor and bearing are positioned by the retaining seat 93 and the positioning member 95 respectively, disengagement of both of the rotor 50 and the bearing 30 of the motor 1, 1a, 1b of the present invention is avoided merely by the single-component design, namely the positioning member 40, 40a, 40b. Accordingly, an amount of components of the motor 1, 1a, 1b of the present invention is decreased to reduce structural complexity.

Second, convenience of assembling is provided. Owing to the simplified structure of the motor 1, 1a, 1b, after the stator 20, 20b and the bearing 30 are mounted to the shaft tube 11 of the base 10, 10a, 10b, a quick assembling merely including fixing the positioning member 40, 40a, 40b to the shaft tube 11 and coupling the rotor 50 to the base 10, 10a, 10b is provided. The more important is that without the retaining seat 93 of the conventional motor 9 leads to fewer steps in assembling and reliable combination of related components.

Third, revolving stability is enhanced. By the positioning member 40, 40a, 40b, preventing departure of the rotor 50 from the shaft tube 11 can be achieved, so that a distal part of the shaft 51, which has a predetermined length in a longitudinal direction of the shaft 51 and is below the bearing 30, for being received in a retaining seat is not necessary. Accordingly, the motor 1, 1a, 1b of the present invention without a need for the predetermined length can increase the support area between the bearing 30 and the shaft 51 to improve revolving stability of the rotor 50 effectively.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A motor, comprising:
a base including a shaft tube with a closed end and an open end;
a stator being mounted around the shaft tube;
a bearing including a first end face, a second end face and an axial hole connecting with the first and second end faces, with the bearing being received in the shaft tube;
a positioning member including a body fixed to the open end of the shaft tube, with a bottom face of the body that faces the shaft tube forms a pressing portion, with a plurality of retaining plates being formed on an inner radial periphery of the body and extending inwards radially, with a slit being formed between a pair of retaining plates adjacent to each other, with each retaining plate having a retaining end that is a free end of each retaining plate without contacting with the body, with the retaining ends jointly defining a through hole aligned with the axial hole of the bearing; and
a rotor including a shaft passing through the through hole of the positioning member and the axial hole of the bearings, with the shaft having an annular groove formed in an outer periphery thereof to form a neck of the shaft, with the neck being in the through hole of the positioning member while a periphery of the through hole of the positioning member surrounds the annular groove, with the retaining ends of the retaining plates being in the annular groove.

2. The motor as defined in claim 1, wherein a coupling section is formed on an end edge of the shaft tube and adjacent to the open end of the shaft tube, and a coupling portion is formed on an outer bottom edge of the body and surrounding the pressing portion, with the coupling portion engaging with the coupling section.

3. The motor as defined in claim 1, wherein an outer circumference of the shaft tube forms an auxiliary engaging portion between the closed end and the open end of the shaft tube, and a bottom of the stator forms a first connecting portion engaging with the auxiliary engaging portion.

4. The motor as defined in claim 3, wherein a top of the stator forms a second connecting portion engaging with an outer radial periphery of the body of the positioning member.

5. The motor as defined in claim 1, wherein an annular protrusion is formed on the inner periphery of the body and above the retaining plates to define a hole for the shaft to pass through.

6. The motor as defined in claim 1, wherein an annular wall is formed on a top of the body of the positioning member and extends axially, with the annular wall being outside the shaft tube and surrounding the shaft.

7. The motor as defined in claim 1, wherein the pressing portion abuts against the second end face of the bearing.

8. The motor as defined in claim 1, wherein a washer is disposed inside the shaft tube and on the second end face of the bearing, with the pressing portion abutting against the washer.
